(19) United States
(12) Patent Application Publication
(10) Pub. No.: US 2010/0104851 A1
(43) Pub. Date: Apr. 29, 2010

(54) OPTICAL FILM AND METHOD OF MAKING THE SAME

(76) Inventors: Chang-Jian Weng, Chiayi City (TW); Shih-Pin Lin, Taipei City (TW); Ming-Huei Chen, Taoyuan County (TW); Chin-Sung Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/499,093

(22) Filed: Jul. 8, 2009

(30) Foreign Application Priority Data
Oct. 28, 2008 (TW) 097141334

(51) Int. Cl. B32B 3/26; H01B 1/12; B05D 5/00

(52) U.S. Cl. 428/315.5; 428/318.4; 252/500; 427/243; 977/773

(57) ABSTRACT

A low reflective, anti-static and anti-fouling optical film, and a forming method thereof are disclosed. The forming method includes mixing an alkoxy silane, a fluoride-modified alkoxy silane, a conductive material and a pores formation agent to form a coating composition. Subsequently, the coating composition is solidified to form an optical film. The optical film includes a silicon oxide compound with fluorine element, the conductive material mixed therein, and a plurality of three-dimensional mesoporous. Therefore, the optical film of the present invention can simultaneously provide a low reflection, an anti-static effect and an anti-fouling effect.

### BACKGROUND OF THE INVENTION

1. Field of the Invention

The present invention relates to an optical film and a related forming method, and more particularly, to an optical film that can simultaneously provide a low reflection, an anti-static effect and an anti-fouling effect.

2. Description of the Prior Art

In a conventional display device, in order to prevent the image interference caused by reflected light, substrates or films are usually coated with an anti-reflection coating layer having low reflectance so as to lower the reflectivity thereof. However, the anti-reflection material generally can include insulating resin, which accumulates electric charges easily. Therefore, static electricity is easily occurred on the surfaces, and result in contaminations caused by dust deposition. To reduce the contaminations caused by static charges, the insulating resin conventionally has anti-static agent added therein such as ionic surfactants or electrically conductive polymer, or metal oxide particles such as zinc oxide (ZnO), tin oxide (SnO), antimony-doped zinc oxide (ATO) or tin-doped indium oxide (ITO) so as to increase the electrical conductivity thereof and accomplish the anti-static effect. However, since both the aforementioned anti-static agent and metal oxides are materials having high refractive indexes, the refractive index of the formed anti-static resin layer is accordingly too large than the proper refractive index, and the effect of the anti-reflection coating layer is therefore lowered.

To accomplish both the low reflectance and anti-static effect, a complex film structure has been researched and formed. For example, a complex film structure consisting of an anti-reflective film and an anti-static film stacked together is disclosed in US patent application with the publication No. 2006/0029818A by DAI NIPPON PRINTING CO., LTD. As shown in FIG. 1, the complex film structure 10 has at least two optical films coating on a transparent substrate 12. For instance, an anti-static conductive film 14, a hardcoat film 16 and a low reflective film 18 are formed on the transparent substrate 12. The conductive film 14 can provide anti-static effect but increases reflectance and thus lower the anti-reflection effect conversely. Since the conductive film 14 has poor scratch resistance, the hardcoat film 16 and low reflective film 18 are additionally disposed so as to provide protection and anti-reflection effect.

Although both the low reflectance and anti-static effect are disclosed in US patent publication 2006/0029818A, the forming of the complex film structure layer includes several steps, which include a lot of coating steps, a lot of baking processes and a lot of attachment process, and accordingly makes an obvious increase about the forming complexity. Consequently, not only the procedure time is increased, but also the process yield is lowered. Hence, how to develop an optical film, which can be formed with simplified complexity and has more preferable properties, is still a challenge that the industries give every effort to improve.

### SUMMARY OF THE INVENTION

The main objective of the present invention is to provide an optical film and a forming method thereof. The optical film of the present invention can simultaneously provide multiple functions with a low reflection, an anti-static effect and an anti-fouling effect.

To achieve the aforementioned objective, the present invention provides an optical film, which includes a fluoride-modified silicon oxide compound, a plurality of pores and an electrically conductive material. The pores, which are disposed respectively in the interior and on a surface of the fluoride-modified silicon oxide compound, enable the fluoride-modified silicon oxide compound to form a porous optical film having an unsmooth surface thereof and having electrically conductive material dispersed and doped therein.

Besides, the present invention further provides a forming method of an optical film. Firstly, a coating composition is prepared by forming a mixture of a first solvent, an alkoxy silane, a fluoride-modified alkoxy silane, an electrically conductive material and a pores formation agent. Next, a film is formed by solidifying a coating composition. Afterwards, a porous optical film is formed by dissolving the pores formation agent out from the aforementioned film. Consequently, the porous optical film has a plurality of pores respectively disposed in the interior thereof and on the surface thereof.

The optical film according to the present invention can include a silicon oxide compound with fluorine element, the electrically conductive material mixed therein, and a plurality of three-dimensional mesoporous. Therefore, the optical film of the present invention can simultaneously provides a low reflection, an anti-static effect and anti-fouling effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view diagram illustrating a conventional complex film structure.

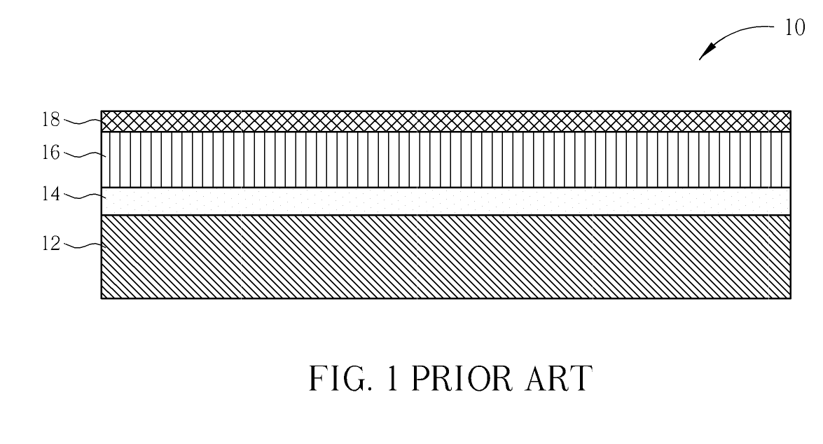

FIG. 2 is a flowchart diagram illustrating the forming method of the optical film according to a preferred embodiment of the present invention.

FIG. 3 is a cross-sectional view diagram illustrating an optical film according to the aforementioned forming method of the present invention.

FIG. 4 is a schematic diagram illustrating a reaction flowchart according to the first example.

FIG. 5 is a schematic diagram illustrating a reflection plot according to the first example.

FIG. 6 shows a data table of test results for the examples of the present invention and the comparative examples.

### DETAILED DESCRIPTION

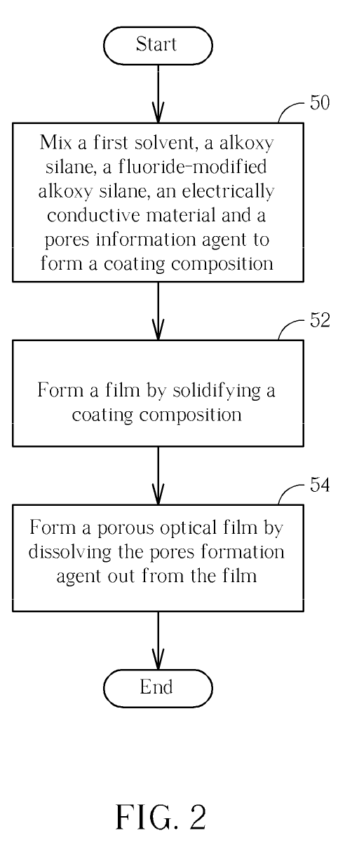

Refer to FIG. 2, which is a flowchart diagram illustrating a forming method of an optical film according to a preferable example of the present invention. As shown in the step 50 of FIG. 2, firstly, by virtue of a sol-gel method, a coating composition is prepared by forming a mixture substantially consisting of a first solvent, an alkoxy silane, a fluoride-modified alkoxy silane, an electrically conductive material and a pores formation agent. The said mixture can also includes other components, such as an additive, in other embodiment.

The aforementioned alkoxy silane substantially can include any kind of silica precursor such as tetramethyl orthosilicate (TMOS), tetraethyl orthosilicate (as also referred to as TEOS or tetraethoxysilane) or a mixture thereof. The aforementioned fluoride-modified silicon oxide compound substantially can include any alkoxy silane with fluoride element such as tridecafluoro-1,1,2,2-tetrahydrooctyl-trimethoxysilane (TDF-TMOS).

The electrically conductive material can include nanometer-scale metal material, nanometer-scale metal oxide particles, ionic surfactants or electrically conductive polymer such as polyaniline (PAn), polythiophene (PTh), a solution having gold nanoparticles, a solution having silver nanoparticles, a solution having carbon nanotube, ZnO, SnO, ATO or ITO or a mixture of at least two of the aforementioned materials. In other embodiments, the electrically conductive material can include electrically conductive polymer such as a copolymer with crosslinked lumps copolymerized by both the polypropylene oxide (PPO) and polyethylene oxide (PEO) and single polymer composites polymerized by either PPO monomers or PEO monomers but not limited thereto.

The above-mentioned pores formation agent can include any small molecule materials that are selectively dissolvable. In other words, an extraction technique can be used so that the pores formation agent can be dissolved out by a second solvent, where the aforementioned second solvent has a dissolving ratio of the pores formation agent to the optical film, and the dissolving ratio is much larger than one (>>1). For instance, the preferable pores formation agent can include glucose, urea, sucrose, polyvinyl alcohol (PVA), polyethyleneglycol (PEG) or a mixture thereof. Among them, the aforementioned coating composition can be further mixed with a PH adaptor or other necessary additives added therein such as hydrochloric acid (HCl), which can assist to perform a sol-gel method to enhance hydrolysis rate greatly or provide other additional effects or functions but not limited thereto. The PH adaptor can be any material capable of adjusting PH values, where the types and molecular weight of the PH adaptor are without particular limitation.

As shown in the step 52 of FIG. 2, next, a film is formed by solidifying the coating composition layer coating thereon. The steps of solidifying a coating composition layer can include: uniformly coating a surface of the substrate by a coating composition, and baking the coating composition sequentially to form a film. The formed film after baking is preferable a transparent film, which includes fluoride-modified silicide oxide compound with a crosslinked structure, the pores formation agent and electrically conductive material therein. The fluoride-modified silicide oxide compound can be a film including silica with fluoride element. According to one concrete example of the present invention, the fluoride-modified silicon oxide compound described herein mainly includes a cross-linking silica structure via Si—O bonds, and they can be bonded between trifluoromethyl (—CF₃) group and the silica structure. The ways of coating the surface of the substrate with the coating composition can include several methods such as air-scraper coating method, scraper coating method, spray coating method, dip coating method, spin-coating method, screen printing method and roll coating method.

The aforementioned substrate, which is not limited to any kind of material, can be as a color filter substrate or a thin film transistor array substrate, or any films included in a liquid crystal display (LCD), a CRT, a plasma display, an OLED display, or an optical glass device. However, the described substrate is preferable as a transparent substrate but not limited thereto. Herein, the substrate can be a glass substrate, a thermoplastic substrate or a thermosetting substrate. For instance, the substrate material can include polyethylene terephthalate (PET), triacetyl cellulose (TAC), cycloolefin polymer (COP), polymethyl methacrylate (PMMA), polycarbonate (PC) or a mixture thereof.

As illustrated in the step 54 of FIG. 2, afterwards, a porous optical film is formed by utilizing the second solvent to dissolve the pores formation agent out from the film. The porous optical film has a plurality of pores disposed in the interior and on the surface. The second solvent has a dissolving ratio of the pores formation agent to the optical film, and the dissolving ratio is much larger than one (>>1) so that the pores formation agent can be easily removed. Additionally, the second solvent can be an aqueous solvent, an organic solvent and a mixture thereof such as a mixture of ethanol and water with a component ratio of 1. Each diameter of the formed pores according to the present invention is substantially in the range about 1 nm to 50 nm so to as achieve an anti-fouling effect and a low reflection. The preferable diameter is substantially in the range 1 nm to 20 nm so as to provide a preferable anti-fouling effect and a lower reflection but not limited thereto. The pores disposed on the surface of the porous optical film enables the porous optical film to have an unsmooth and coarse surface. Additionally, the shapes, amount and density of the pores disposed in the interior of the porous optical film are not limited by the diagrams. However, the pores can be with tubular shapes, circular shapes, ellipse shapes or irregular shapes, and a part of pores may be connected with each other.

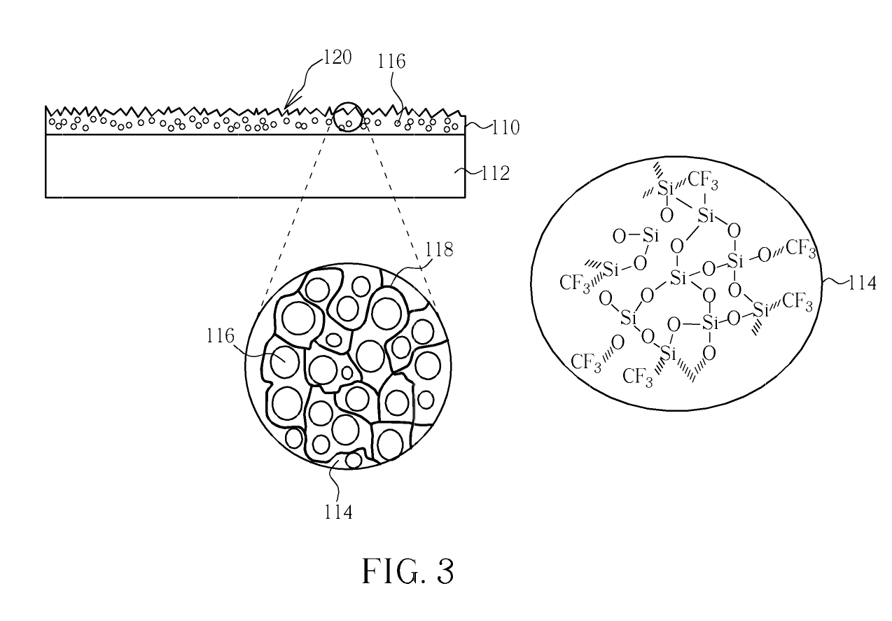

Refer to FIG. 3, which is a cross-sectional view diagram of the optical film according to the aforementioned forming method of the present invention. As illustrated in FIG. 3, the optical film 110 disposed on a surface of a substrate 112 includes a fluoride-modified silicon oxide compound 114, a plurality of pores 116 and an electrically conductive material 118. The pores 116, which are disposed in the interior of fluoride-modified silicon oxide compound 114 and on the surface of fluoride-modified silicon oxide compound 114, enable the fluoride-modified silicon oxide compound 114 to form a porous optical film having an unsmooth and coarse surface 120. Additionally, the electrically conductive material 118 is dispersed and doped in the porous optical film.

The electrically conductive material 118 is tangled in the framework of the porous optical film with crosslinked bonding structure so as to provide the anti-static property, and accordingly not easy detached. The material of the fluoride-modified silicon oxide compound 114 forms a crosslinked structure and originally has low refractive property and low cohesion force property. After dissolving the pores formation agent out, a plurality of three-dimensional pores 116 with nanometer scale are formed in the interior of the optical film 110. Each of the pores 116 forms a slight concave-convex structure on the surface of the optical film 110. The nano-scale structures formed on the surface by the air positioned within the pores 116 and the pores 116 can further lower the reflectivity of the optical film 110. In addition, since the fluoride-modified silicon oxide compound 114 originally has lower cohesion force and the villus-like nano structure within the optical film 110 caused by the pores 116, the optical film 110 is capable of having lotus effect to further enhance anti-flouring ability accordingly.

The included scope for application according to the optical film of the present invention has no particular limitation and can be applied to a color filter substrate of the LCD panel or any films of the thin film transistor array substrate, the LCD panel, the CRT, the plasma display or the OLED display panel or the optical glass element.

Hereafter, several concrete examples are listed to illustrate the optical film and the forming method thereof and are compared with comparative examples.

### EXAMPLE 1

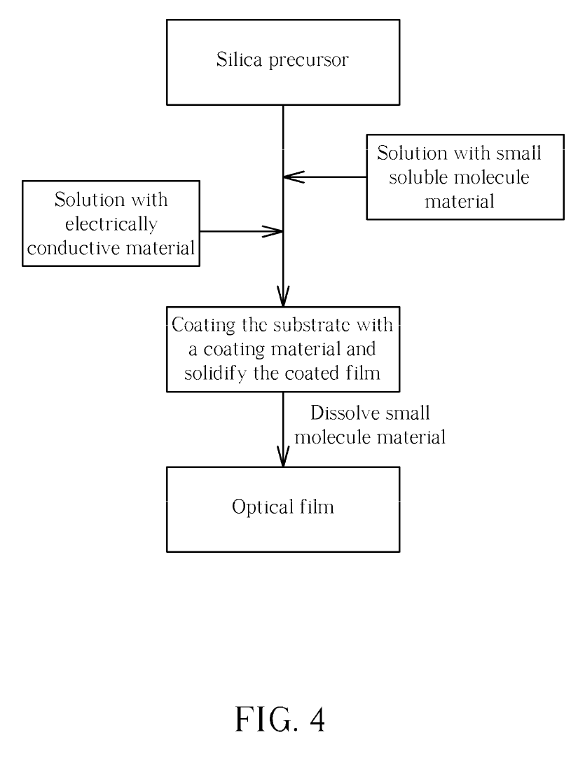

With reference to FIG. 4, FIG. 4 is a reaction flowchart according to example 1. Firstly, about 20.8 g of TEOS, about 7 g of TDF-TMOS, about 20 g of isopropanol solvent (IPA) and about 7 g of 0.1N HCl solution are added and mixed in the reaction bottle so as to be homogeneously blended by stirrer for 30 minutes at room temperature. Next, stirring step is stopped. The homogenous transparent solution is reacted at a temperature of 70° C. for 2 hours and afterward cooled to room temperature. Next, about 3 g of prepared 0.8M aqueous D-glucose solution (where M is the molar concentration) is added into the aforementioned sticky and mixed solution for homogenous blending. In addition, about 7 g of 10 wt % aqueous PAn solution is also added into the aforementioned sticky and mixed solvent for homogenous blending, too. Accordingly, a coating composition is formed through diluting by adding IPA.

Afterwards, the film is formed through the treatment for coating the coating composition on the transparent substrate, such as PET or TAC, and sequentially baking the coating composition at 80° C. for over 5 hours. Finally, the film is dipped into a mixed solution with ethanol-to-water ratio 1:1 (v/v) for several seconds to dissolve glucose, and a transparent optical film is formed after another baking step.

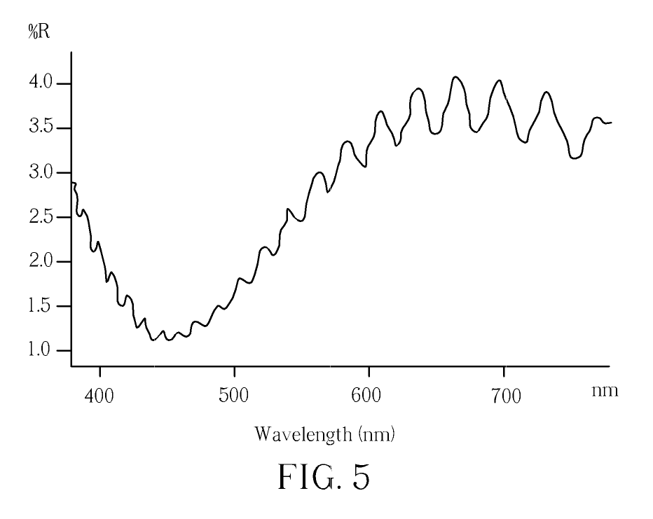

Subsequently, the formed optical film according to the example 1 can undergo an optical testing, and FIG. 5 is a schematic diagram illustrating the reflective curve of the formed optical film according to example 1. As illustrated in FIG. 5, the optical film according to example 1 has good anti-reflection in visible-wavelength region especially the wavelength in the range from 400 nm to 500 nm having lower reflectivity (<2 wt %).

### EXAMPLE 2

A reaction flowchart according to example 2 is similar to that according to example 1. However, in example 2, the weight of TDF-TMOS increases to about 10 g, and the amount of aqueous PAn solution decreases to about 5 g. A transparent optical film is therefore formed through the flowchart illustrated in FIG. 4 with different recipes.

### COMPARATIVE EXAMPLE 1

The main difference between comparative example 1 and example 2 is that the comparative example 1 does not include the step of adding glucose, the step of adding aqueous PAn solution and the step of dissolving glucose. The forming steps are shown as follows:

Firstly, about 20.8 g of TEOS, about 10 g of TDF-TMOS, about 20 g of IPA and about 7 g of 0.1N HCl solution are added and mixed in the reaction bottle so as to be homogeneously blended by stirrer for 30 minutes at room temperature. Next, the stirring step is stopped. The homogenous transparent solution is continually reacted at a temperature of 70° C. for 2 hours and cooled to room temperature sequentially. Afterwards, after the aforementioned mixed solvent diluted with IPA, the film is formed through the treatment for coating the coating composition on a transparent substrate, such as PET or TAC, and sequentially baking the coating composition at 80° C. for over 5 hours.

### COMPARATIVE EXAMPLE 2

The main difference between comparative example 2 and example 2 is that the comparative example 2 does not include the steps of adding aqueous PAn solution and IPA, and the amount of the glucose is lower to about 3 g. The forming steps are shown as follows:

Firstly, about 20.8 g of TEOS, about 10 g of TDF-TMOS, about 20 g of IPA and about 7 g of 0.1N HCl solution are disposed and mixed in the reaction bottle so as to be homogeneously blended by stirrer for 30 minutes at room temperature. Afterwards, the stirring step is stopped. The homogenous transparent solution is continually reacted at a temperature of 70° C. for 2 hours and cooled to room temperature sequentially. Next, about 3 g of prepared 0.8M aqueous D-glucose solution (where M is the molar concentration) is added into the aforementioned sticky and mixed solvent for homogenous blending. Afterwards, the film is formed through the treatment for coating the coating composition on a transparent substrate such as PET or TAC and sequentially baking the coating composition at 80° C. for over 5 hours. Finally, the film is dipped into a mixed solution with ethanol-to-water ratio 1:1 (v/v) for several seconds to dissolve glucose, and a transparent optical film is formed after another baking step.

### COMPARATIVE EXAMPLE 3

The main difference between comparative example 3 and example 1 is that the comparative example 3 does not include the steps of adding glucose and dissolving glucose. The forming steps are shown as follows:

Firstly, about 20.8 g of TEOS, about 7 g of TDF-TMOS, about 20 g of IPA and about 7 g of 0.1N HCl solution are disposed and mixed in the reaction bottle so as to be homogeneously blended by stirrer for 30 minutes at room temperature. Afterwards, the stirring step is stopped The homogenous transparent solution is continually reacted at a temperature of 70° C. for 2 hours and cooled to room temperature sequentially. Additionally, about 7 g of 10 wt % aqueous PAn solution is added into the aforementioned sticky solvent for homogenous blending. Afterwards, after the aforementioned mixed solvent diluted with IPA, the film is formed through the treatment for coating the coating composition on the transparent substrate such as PET or TAC and sequentially baking the coating composition at 80° C. for over 5 hours.

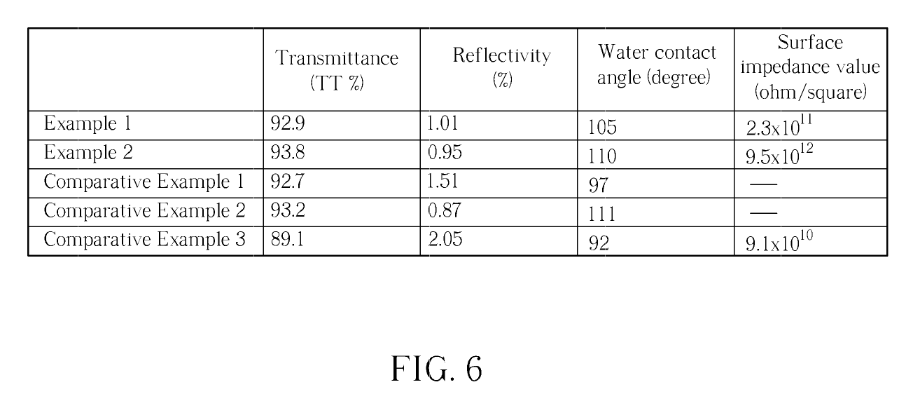

To more precisely explain the functions about the optical films according to the present invention, FIG. 6 shows various testing data for the optical film according to the examples and comparative examples of the present invention. The comparative example 1 and comparative example 2 does not have electrically conductive material with anti-static property added therein and accordingly are incapable of accomplishing anti-static effect and incapable of getting testing results of surface impedance value. As illustrated in FIG. 6, in comparison with the optical films of example 1 and example 2, the comparative example 1 without having glucose and PAn has lower transmittance of the optical film, higher reflectivity (poor anti-reflection) and lower water contact angle (poor anti-fouling effect). In the comparative example 2 with lower glucose and no PAn, the transmittance of the optical film and water contact angle in the comparative example 2 are almost identical to those in the example 1 and the example 2. The achieved reflectivity for the comparative example 2 is lower. The comparative example 2 has no anti-static effect and can accordingly lead to dust deposition problem. Although the comparative example 3 having PAn but without having glucose is capable of achieving anti-static effect but owns obviously low transmittance (poor optical properties), obviously high reflectivity (poor anti-reflection) and obviously low water contact angle (poor anti-fouling effect).

In summary, the present invention provides an optical film, which can have a silicon oxide compound with fluorine element, electrically conductive material doped therein and three-dimensional mesoporous. The integration of above three characteristic enables the single optical film according to the present invention to have multiple functions of anti-fouling, anti-static effect and anti-reflection. Therefore, the optical film according to the present invention not only can have simplified process complexity but also maintain its good optical property. Actually, the optical film can provide preferred completely multiple functions.

Those skilled in the art will readily observe that numerous modifications and alterations of the device and method may be made while retaining the teachings of the invention.

What is claimed is:

1. An optical film, comprising:
a fluoride-modified silicon oxide compound;
a plurality of pores disposed both in an interior of the fluoride-modified silicon oxide compound and on a surface of the fluoride-modified silicon oxide compound so that the fluoride-modified silicon oxide compound is a porous optical film and that the porous optical film has a unsmooth surface; and
an electrically conductive material dispersed and doped in the porous optical film.

2. The optical film of claim 1, wherein the fluoride-modified silicon oxide compound comprises fluoride-modified silica.

3. The optical film of claim 1, wherein the fluoride-modified silicon oxide compound comprises trifluoromethyl group (—CF₃).

4. The optical film of claim 1, wherein the pores are nanometer-scale pores.

5. The optical film of claim 1, wherein the electrically conductive material comprises conductive polymer.

6. The optical film of claim 5, wherein the electrically conductive material comprises polyaniline (PAn), polythiophene (PTh) or a mixture thereof.

7. The optical film of claim 1, wherein the electrically conductive material comprises a nanometer-scale metal material.

8. The optical film of claim 1, wherein the electrically conductive material comprises gold nanoparticles, silver nanoparticles, carbon nanotubes or a mixture thereof.

9. A forming method of an optical film, comprising:
mixing a first solvent, an alkoxy silane, a fluoride-modified alkoxy silane, an electrically conductive material and a pores formation agent to form a coating composition;
solidifying the coating composition to form a film; and
dissolving the pores formation agent from the film to form a porous optical film, wherein the porous optical film has a plurality of pores disposed both in an interior and on a surface thereof.

10. The forming method of claim 9, wherein the step of solidifying the coating composition comprises:
coating a surface of a substrate with the coating composition; and
baking the coating composition to form the film.

11. The forming method of claim 10, wherein the substrate comprises a glass substrate, a thermoplastic substrate and a thermosetting substrate.

12. The forming method of claim 11, wherein the substrates comprise polyethylene terephthalate (PET), triacetyl cellulose (TAC), cycloolefin polymer (COP), polymethyl methacrylate (PMMA), polycarbonate (PC) or a mixture thereof.

13. The forming method of claim 9, wherein the alkoxy silane comprises tetramethyl orthosilicate (TMOS) and tetraethyl orthosilicate (TEOS) or a mixture thereof.

14. The forming method of claim 9, wherein the step of mixing process comprises mixing a PH adaptor, the first solvent, the alkoxy silane, the fluoride-modified alkoxy silane, the electrically conductive material and the pores formation agent.

15. The forming method of claim 9, wherein the pores formation agent comprises glucose, urea, sucrose, polyvinyl alcohol (PVA), polyethyleneglycol (PEG) or a mixture thereof.

16. The forming method of claim 9, wherein the fluoride-modified alkoxy silane comprises tridecafluoro-1,1,2,2-tetrahydrooctyl-trimethoxysilane (TDF-TMOS).

17. The forming method of claim 9, wherein the electrically conductive material comprises an electrically conductive polymer or a nanometer-scale metal material.

18. The forming method of claim 17, wherein the electrically conductive material comprises polyaniline (PAn), polythiophene (PTh), gold nanoparticles, silver nanoparticles, carbon nanotubes or a mixture thereof.
